(19) United States
(12) Patent Application Publication
(10) Pub. No.: US 2005/0174010 A1
(43) Pub. Date: Aug. 11, 2005

(54) Motor brush holder and alignment assembly

(76) Inventors: Eugene B. Porter, Auburn Hills, MI (US); Werner Saussele, Besigheim (DE); Frank R. Lombardo, Rochester, NY (US); Christopher Jones, Dayton, OH (US); Bernd Walther, Bietigheim-Bissingen (DE)

Correspondence Address: ATTN: Andrew R. Basile;YOUNG & BASILE, P.C., SUITE 624, 3001 WEST BIG BEAVER ROAD, TROY, MI, 48084-3107, US

(21) Appl. No.: 10/302,450

(22) Filed: Nov. 22, 2002

Related U.S. Application Data
(63) Continuation of application No. 09/628,912, filed on Jul. 31, 2000, now abandoned.

(51) Int. Cl. H02K 13/00

(52) U.S. Cl. 310/239

(57) ABSTRACT

A motor housing assembly includes a motor housing with two magnets disposed in the housing in a spaced relationship and a brush holder that couples with the motor housing. The magnets are disposed inside the motor housing to form two spaces in between the magnets. The brush holder has two tabs that extend inside the motor housing in between the two spaces. The tabs allow the brushes in the brush holder to be aligned solely based on the magnet position to ensure that there is proper angular alignment between the brushes and the magnets.

### CROSS-REFERENCE TO RELATED APPLICATION

This application is a continuation application of Ser. No. 09/628,912 filed on Jul. 31, 2000.

### TECHNICAL FIELD

The present invention is directed to a motor assembly, and more particularly to an assembly that aligns the brushes with the magnets and commutator in the motor.

### BACKGROUND ART

Consistent, reliable motor performance depends on proper alignment between the brushes, the commutator, and the magnets in the motor. In a conventional motor structure, the brushes are located in a brush housing and the commutator and magnets are located in a motor housing. The two housings are joined together to form the motor assembly. To align and join the two housings, a known motor housing structure may include flats that engage with ribs formed on the brush housing to align the motor assembly. A variation of the above-described conventional structure includes peg-like structures in the brush housing that frictionally engage with holes drilled in flanges extending outwardly from the motor housing.

Prior art motor assemblies, however, depended on following precise tolerances in the positioning of the magnets and commutator within the motor housing with respect to the flanges on the outside of the motor housing. Because the magnet position within the motor housing, the flange position, the brush position, and the fit tolerances are all independently variable with respect to each other, obtaining consistent alignment of the brushes with both the commutator and the magnets can be difficult because the magnets must first be positioned precisely in the motor housing with respect to the flanges, and the tolerances of the flanges must be precise enough to ensure that the brushes are correctly aligned with the magnets and commutator.

These variables tend to cause performance variations as well as added complexity in the manufacturing process.

There is a need for a motor housing assembly that improves the alignment of the brushes to the magnets and the commutator and minimize performance variations from motor to motor.

### SUMMARY OF THE INVENTION

Accordingly, the present invention is directed to a motor housing assembly that includes a motor housing, a pair of magnets disposed within the motor housing in a spaced relationship to form at least one space, and a brush holder having at least one tab that fits within said at least one space in between the pair of magnets. One preferred embodiment positions the magnets within the housing to form two spaces lying opposite each other. The brush housing in this embodiment has two tabs that extend into the two spaces formed by the magnet pair.

Because the present invention aligns the brushes based on the magnet position and not on physical attributes of the motor housing, such as external flanges, the inventive structure prevents the brush position from being completely independent of the magnet position, as in prior art devices. Instead, the inventive structure aligns the brushes based on the magnet position, thereby ensuring a consistent positional relationship between the magnet and the brushes from device to device.

### BRIEF DESCRIPTION OF THE DRAWINGS

FIG. 1 is an exploded view of a motor housing assembly of the present invention;

FIG. 2 is an isometric view of the motor housing interior in the present invention; and

FIG. 3 is a sectional view of the motor housing assembly of the present invention after the motor housing and brush holder shown in FIGS. 2 and 3 are assembled together.

### DETAILED DESCRIPTION OF THE PREFERRED EMBODIMENTS

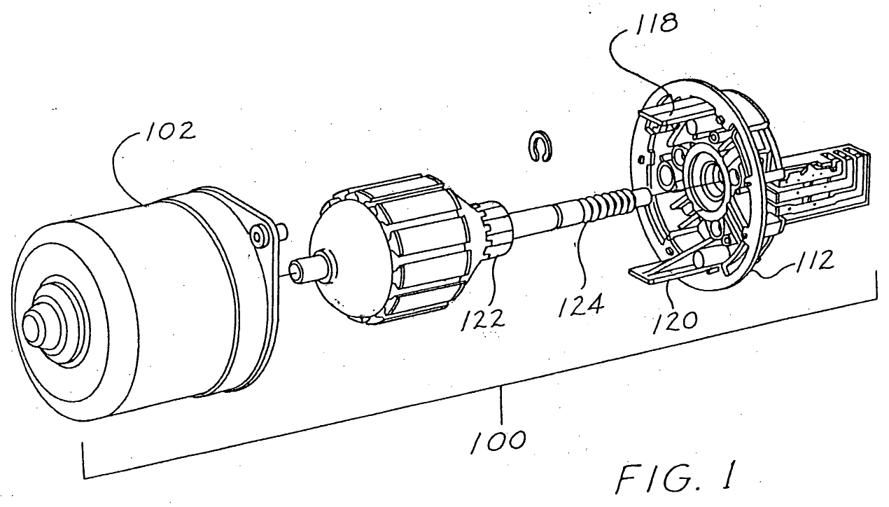

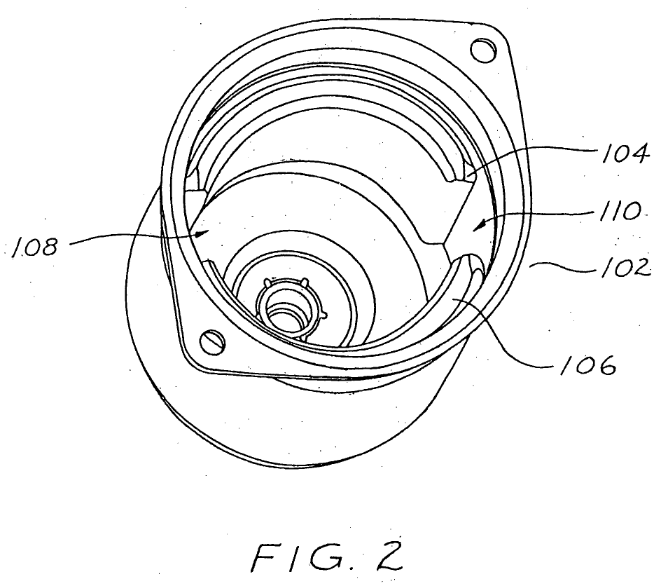

FIG. 1 is an exploded view of the motor housing assembly 100 of the present invention, and FIG. 2 is an isometric view of a motor housing used in the assembly 100. The assembly 100 includes a motor housing 102 that holds a pair of magnets 104, 106. The magnets 104, 106 are preferably attached to the motor housing 102 in a spaced relationship to form two spaces 108, 110 that are disposed opposite each other, as can be seen more clearly in FIG. 2. These spaces 108, 110 will be used for aligning brushes with the magnets 104, 106, which be explained in greater detail below. Because the inventive assembly 100 does not rely upon engagement of any portion of the motor housing 102 for brush alignment, the motor housing 102 does not require the magnets 104, 106 to be positioned precisely with respect to any flanges or any other portion of the motor housing 102.

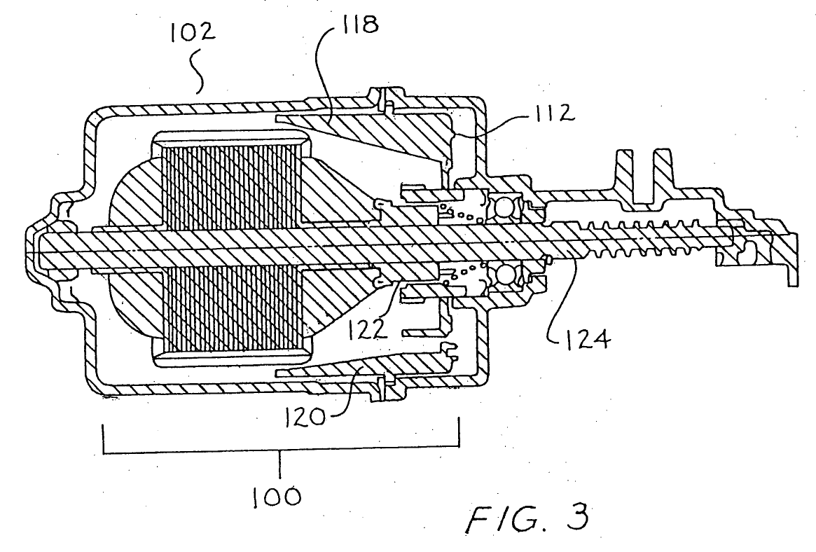

The assembly also includes a brush holder 112 that holds several brushes (not shown) and has a pair of tabs 118, 120 extending from the main body portion 116. The spacing and position of the tabs 118, 120 correspond with the position of the spaces 108, 110 between the magnets in the motor housing 102 so that the tabs 118, 120 extend into the motor housing 102 via the spaces 108, 110, as can be seen in FIG. 3, when the motor housing 102 and the brush holder 112 are assembled together. Preferably, the tabs 118, 120 fit within the spaces 108, 110 in a sliding manner. The brush holder 112 can be made of any material conventionally used to construct brush holders. Further, because the brush holder 112 does not need to engage with any portion of the motor housing 102 in a frictional or interference fit, the tabs 118, 120 do not need to conform to extremely close tolerances.

Referring to FIGS. 1 and 3, the motor housing 102 and brush holder 112 are assembled together with a commutator 122 and an armature shaft 124, like conventional motor assembly structures. As can be seen from the Figures, the tabs 118, 120 extend into the spaces 108, 110 formed by the magnets 104, 106 to align the brushes (not shown) in the brush holder 112 with the magnets 104, 106 and the commutator 122. After assembly, the tabs 118, 120 lie on either side of the commutator 122. Because the orientation of the brush holder 112, and therefore the brushes (not shown), depends on the magnet position, the brushes (not shown) will consistently be aligned properly with the magnets 104, 106 regardless of the motor housing's external dimensions and regardless of the magnets' 104, 106 orientation within the housing. More particularly, the magnet/brush alignment in the inventive structure does not depend on aligning the magnets 104, 106 with flanges on the motor housing, nor does it require any frictional engagement or an interference fit between any portion of the motor housing 102 and the brush holder 112.

The inventive structure therefore uses the operational parts of the motor (e.g. the magnets) to align other operational parts of the motor (e.g. the brushes). This structure eliminates the need to position the magnets precisely within the motor housing with respect to flanges or other structures formed on the housing, preventing the brush position from being independent of the magnet position and improving the alignment of the brushes to the magnets and to the commutator.

It should be understood that various alternatives to the embodiments of the invention described herein may be employed in practicing the invention. It is intended that the following claims define the scope of the invention and that the method and apparatus within the scope of these claims and their equivalents be covered thereby.

1. A motor housing assembly comprising:
a motor housing;
at least one pair of magnets having opposing ends positioned within the motor housing in a spaced relationship to form at least one space therebetween; and
a brush holder having a plurality of brushes associated therewith and only a single tab for each space formed between opposing ends of adjacent magnets, where only the single tab extends between each space formed by the opposing ends of the magnets to align the brushes with respect to the magnets separate and independent of the motor housing, such that alignment of the brushes occurs exclusively as a result of interaction between each tab of the brush holder and the corresponding space.

2. The motor housing assembly of claim 1, wherein the pair of magnets are positioned within the housing to form two spaces therebetween and the brush holder has only a single tab extending within each respective space.

3. The motor housing assembly of claim 2, wherein the two spaces are positioned opposite each other and the two tabs on the brush holder are also positioned opposite each other.

4. The motor housing assembly of claim 1, wherein the pair of magnets is attached to an inner surface of the motor housing separate and independent of the brush holder.

5. A motor housing assembly comprising:
a motor housing;
a pair of magnets attached to an inner surface of the motor housing in a spaced relationship to form first and second spaces lying generally opposite from each other;
an armature positioned between the pair of magnets; and
a brush holder having a plurality of brushes and a first tab extending within the first space and a second tab extending within the second space to align the plurality of brushes with the magnets separate and independent of the motor housing, such that alignment of the brushes occurs exclusively as a result of interaction between only the respective tab of the brush holder and the corresponding space between the magnets, the magnets being attached to the housing separate and independent of the brush holder.

6. The motor housing assembly of claim 5, wherein the tabs fit within the two spaces in a sliding engagement.

7. The motor housing assembly of claim 5, wherein the pair of magnets and the tabs surround the circumference of the armature after the motor housing and the brush holder are assembled together.

8. A motor housing assembly comprising:
a motor housing;
at least one pair of magnets having opposing ends positioned within the motor housing to define a space therebetween; and
a brush holder having a plurality of brushes associated therewith and only a single tab with substantially uniform width extending between the opposing ends of the pair of magnets and within the space defined therebetween to align the brushes with respect to the magnets separate and independent of the motor housing, such that alignment of the brushes occurs exclusively as a result of interaction between the single tab of the brush holder and the corresponding space.

9. The motor housing assembly of claim 8, wherein the pair of magnets forms two spaces and the brush holder has two tabs, such that one tab fits into each one of the two spaces.

10. The motor housing assembly of claim 9, wherein the two spaces are positioned opposite each other and the two tabs on the brush holder are also positioned opposite each other.

11. The motor housing assembly of claim 9, wherein the pair of magnets is attached to an inner surface of the motor housing.

12. A method for assembling a motor housing assembly comprising the steps of:
positioning at least one pair of magnets within a motor housing such that opposing ends of adjacent magnets form at least one space therebetween;
positioning a brush holder having a plurality of brushes associated therewith and only a single tab for each space defined between opposing ends of adjacent magnets; and
extending only each single tab within the respective space formed between opposing ends of the adjacent magnets to align the plurality of brushes with the magnet separate and independent of the housing, such that alignment of the brushes occurs exclusively as a result of interaction between each single tab on the brush holder and each corresponding space.

13. A motor housing assembly manufactured according to the method of claim 12 comprising:
a motor housing;
at least one pair of magnets positioned within the motor housing in a spaced relationship such that opposing ends of adjacent magnets form at least one space therebetween; and
a brush holder having a plurality of brushes associated therewith and only a single tab for each space formed between the opposing ends of adjacent magnets, where only the single tab extends between the opposing ends of the adjacent magnets to align the brushes with respect to the magnets separate and independent of the motor housing, such that alignment of the brushes occurs exclusively as result of interaction between each single tab of the brush holder and each corresponding space.

14. The motor housing assembly of claim 13, wherein the pair of magnets is positioned within the housing to define two spaces between opposing ends of the adjacent magnets and the brush holder has only a single tab extending within each respective space.

15. The motor housing assembly of claim 14, wherein the two spaces are positioned opposite each other and the two tabs on the brush holder are also positioned opposite each other.

16. The motor housing assembly of claim 13, wherein the pair of magnets is attached to an inner surface of the motor housing separate and independent of the brush holder.

17. A motor housing assembly manufactured according to the method of claim 12 comprising:
a motor housing;
a pair of magnets attached to an inner surface of the motor housing in a spaced relationship to form first and second spaces lying generally opposite from each other;
an armature positioned between the pair of magnets; and
a brush holder having a plurality of brushes, a first tab extending within the first space and a second tab extending within the second space to align the plurality of brushes with the magnets separate and independent of the motor housing, such that alignment of the brushes occurs exclusively as a result of interaction between the first and second tabs of the brush holder and the corresponding first and second spaces, the magnets being attached to the housing separate and independent of the brush holder.

18. The motor housing assembly of claim 17 further comprising:
the tabs fitting within the two spaces in a sliding engagement.

19. The motor housing assembly of claim 17 further comprising:
the pair of magnets and the tabs surrounding the circumference of the armature after the motor housing and the brush holder are assembled together.

20. A method for locating a motor brush to a magnet in a motor housing assembly comprising the steps of:
attaching at least one pair of magnets within a motor housing such that opposing ends of adjacent magnets define at least one space therebetween;
positioning a brush holder having a plurality of brushes with respect to the attached magnets, the brush holder having a single tab for each space, each tab located in an initial position relative to the space defined between opposing ends of adjacent magnets; and
extending only the single tab between the opposing ends of adjacent magnets defining the space to align the brush holder in a final position of alignment with the magnets separate and independent of the motor housing, such that alignment of the brushes occurs exclusively as a result of interaction between each tab of the brush holder and each corresponding space.

21. The method of claim 20, wherein the at least one pair of magnets is attached to the housing separate and independent of the brush holder.

22. The method of claim 20, wherein each tab is of uniform width.
